(19) United States
(12) Patent Application Publication
(10) Pub. No.: US 2019/0225152 A1
(43) Pub. Date: Jul. 25, 2019

(54) VEHICLE VISION SYSTEM WITH WIRELESS CAMERA ANTENNA AND CHARGING TOPOLOGY

(71) Applicant: Magna Electronics Inc., Auburn Hills, MI (US)

(72) Inventor: Krishna Koravadi, Rochester Hills, MI (US)

(21) Appl. No.: 16/250,503

(22) Filed: Jan. 17, 2019

Related U.S. Application Data
(60) Provisional application No. 62/619,954, filed on Jan. 22, 2018.

(51) Int. Cl. B60R 1/00; B60R 11/04; H04N 5/38; H04N 5/225

(52) U.S. Cl. CPC B60R 1/00; B60R 11/04; B60R 16/033; H04N 5/2253; H04N 5/38

(57) ABSTRACT

A vehicular vision system includes a camera disposed at a rear of a trailer and having a field of view rearward of the trailer. A transmitting antenna is disposed at a front of the trailer and is electrically connected to the camera via an antenna cable. The transmitting antenna receives, via the antenna cable, image data captured by the camera, and the transmitting antenna wirelessly transmits the received captured image data. A receiving device is disposed at a vehicle towing the trailer, and a display device is disposed in the vehicle and viewable by a driver of the vehicle. The receiving device receives the transmitted captured image data, and the display device displays images derived from the received captured image data.

### CROSS REFERENCE TO RELATED APPLICATION

The present application claims the filing benefits of U.S. provisional application Ser. No. 62/619,954, filed Jan. 22, 2018, which is hereby incorporated herein by reference in its entirety.

### FIELD OF THE INVENTION

The present invention relates generally to a vehicle vision system for a vehicle and, more particularly, to a vehicle vision system that utilizes one or more wireless cameras at a trailer being towed by a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras to capture image data representative of images exterior of the vehicle, and provides a method and apparatus to provide enhanced communication between a vehicle control or system and a wireless camera disposed at a rear of a trailer being towed by the vehicle.

When a wireless camera is mounted at the rear of a long metallic trailer, due to the metallic surface as well as the height difference between the vehicle and the trailer, the wireless signal reception will be degraded. Since a very good wireless signal strength is needed to transmit the compressed video, the wireless antenna (associated with the trailer mounted camera) is, in accordance with the present invention, mounted at the front of the trailer surface. Since the wireless camera is designed to be installed temporarily, the antenna cable connected to the wireless antenna may be temporarily held in position by easy installed magnetic mounts.

Because the wireless camera is mounted at the rear of the trailer and there will be limitation of availability of a power source for the camera, the camera may be charged by energy generated by a solar panel at the trailer (such as part of the antenna cable) or a vibration energy harvesting module (that generates electrical energy responsive to vibration of the trailer as the vehicle and trailer travel along a road).

These and other objects, advantages, purposes and features of the present invention will become apparent upon review of the following specification in conjunction with the drawings.

### BRIEF DESCRIPTION OF THE DRAWINGS

FIG. 1 is a top view of a vehicle towing a trailer, showing the wireless range limitation for a wireless camera antenna installed at the rear of the trailer;

FIG. 2 is a side view of the vehicle and trailer of FIG. 1, showing the wireless range limitation for the wireless camera antenna installed at the rear of the trailer;

FIG. 3 is a top view of a vehicle towing a trailer, showing a wireless camera at the rear of the trailer with a wireless antenna mounted at the front surface of the trailer in accordance with the present invention;

FIG. 4 is a side view of the vehicle and trailer of FIG. 3, showing the wireless antenna magnetically mounted at the front surface of the trailer, and showing the receiver antenna mounted inside the driver cabin of the towing vehicle;

FIG. 5 is a side view of a vehicle and trailer, showing a wireless antenna magnetically mounted at the front surface of the trailer with a receiver antenna mounted at the roof top of the towing vehicle;

FIG. 6 is a top view of the vehicle and trailer of FIG. 5, showing an optional solar panel as an integral part of the wireless antenna cable;

FIG. 7A is a side elevation of a wireless camera with remote antenna of the present invention, showing use of a solar panel and/or vibration energy harvesting module for charging a battery of the camera;

FIG. 7B is a schematic of a wireless camera with a wireless charger module for charging a battery of the camera; and

FIG. 8 is a side view of a vehicle and trailer with a wireless camera disposed at the rear of the trailer, showing use of a repeater that receives a wireless signal from the wireless camera and repeats it so that the signal is received at the antenna at the vehicle.

### LEGEND

100—Wireless camera
102—Shielded antenna cable with magnetic mounting (104)
104—Magnetic mounting clamps though which the shielded antenna cable is passed
106—Wireless antenna
108a—vehicle receiver antenna mounted on the roof of the vehicle
108b—vehicle receiver antenna mounted inside the vehicle cabin
110—Display unit integral part of the dash board
112—Vehicle towing the trailer
114—Trailer mounted with wireless camera
116—Wireless beam pattern
118—Solar panel integral part of the antenna cable
120—Vibration energy harvesting module
122—Wireless charge receive module
124—Wireless charger module
126—Electrical energy storage module (Battery)
128—Wireless repeater

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

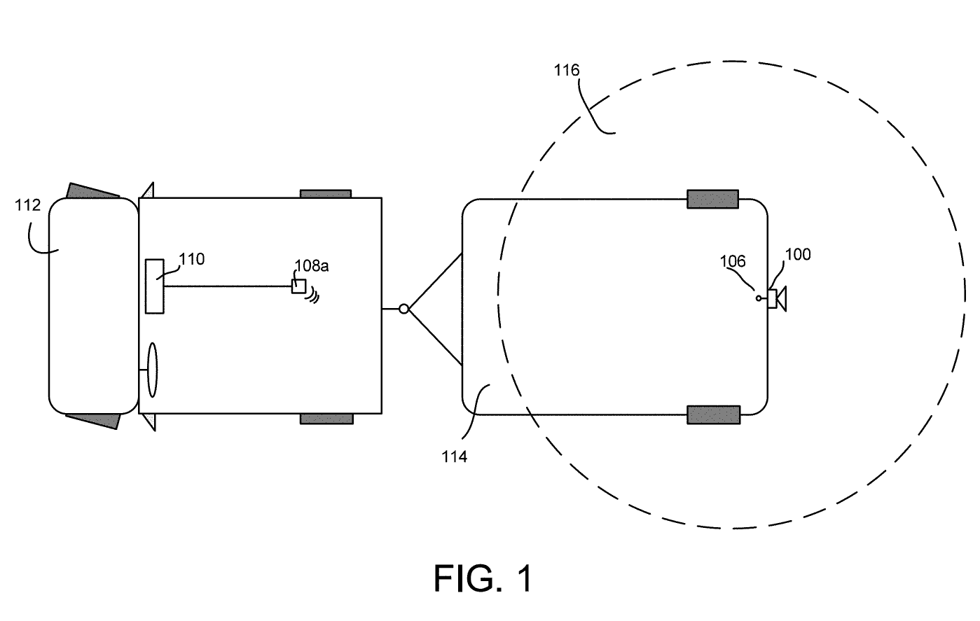

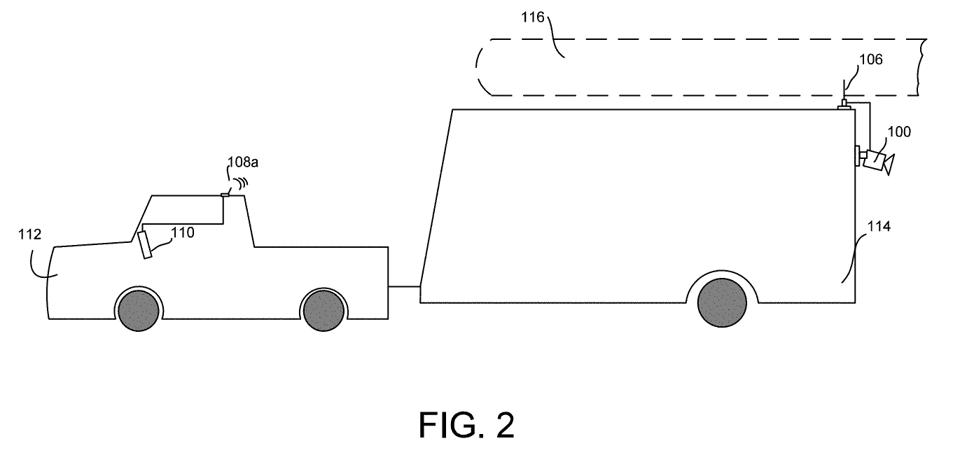

A vision system for a vehicle 12 includes a controller or display 110 at the vehicle, with a receiving antenna 108a at the vehicle for receiving wireless signals transmitted by an antenna 106 of a wireless camera 100 disposed at the rear of a trailer 114. FIGS. 1 and 2 illustrate the top and side view of the wireless range limitation 116 with the Wi-Fi camera 100 and antenna 106 installed at the rear of the trailer 114. In such applications, the transmitting range of the antenna is not sufficient to be well received at the receiving antenna 108a at the vehicle.

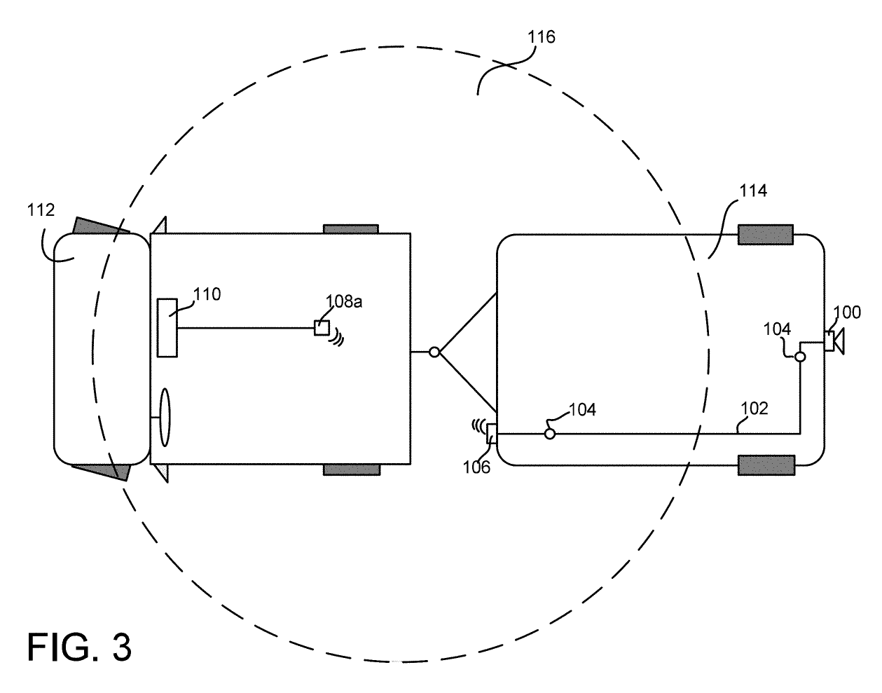

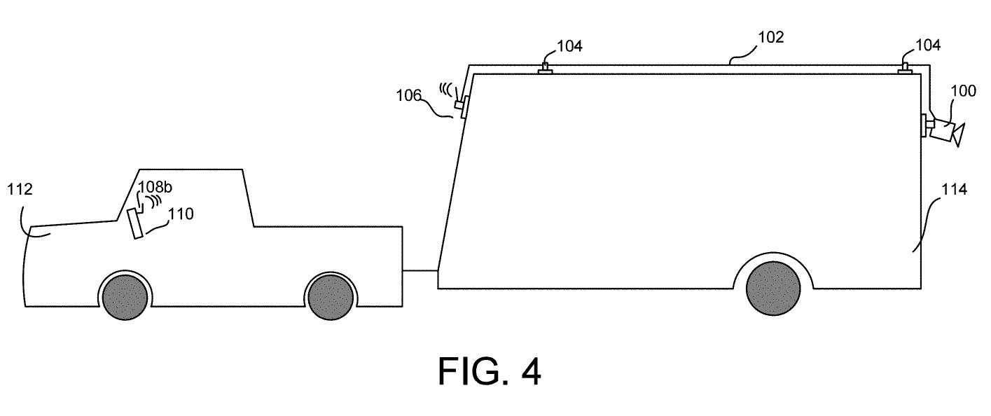

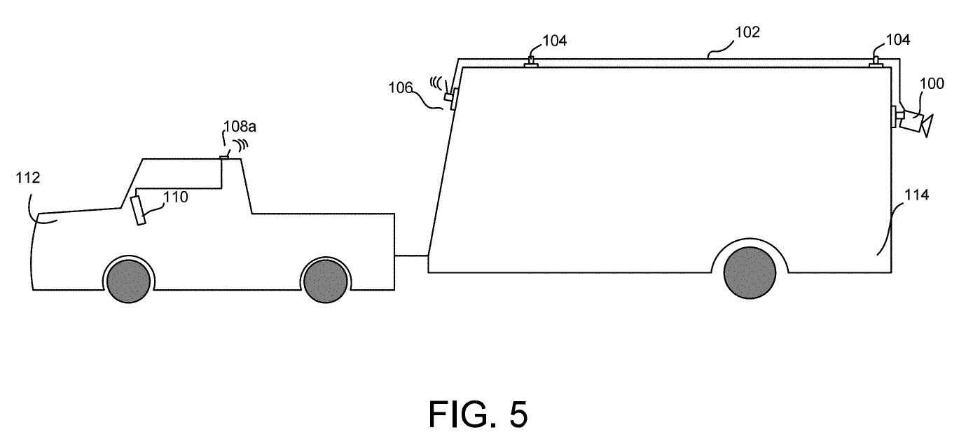

In accordance with the present invention, and such as shown in FIG. 3, the wireless camera 100 at the rear of the trailer 114 has its antenna 106 mounted at a front surface of the trailer 114 and uses a shielded antenna cable 102 installed at the trailer to connect the camera to the antenna. The cable 102 may be securely mounted or retained or secured at the trailer using mounting elements, such as magnetic elements or clamps 104. As shown in FIG. 3, the wireless transmission range 116 of the antenna 106 at the front of the trailer can cover the wireless antenna 108a at the vehicle (such as a wireless antenna 108a at the roof of the vehicle such as shown in FIG. 5 or such as a wireless antenna 108b in the vehicle such as shown in FIG. 4), such that the wirelessly transmitted signals are received by the receiving antenna for the control or display 110, which may function to process the received image signal or data or may display images derived from the received signal or data.

Thus, the system of the present invention provides enhanced communication and/or transmission of signals between a wireless or Wi-Fi camera disposed at a rear of a trailer being towed by a vehicle and a control or device or processor or display device disposed in the vehicle towing the trailer. The system provides a cable that connects to the camera and to a transmitting antenna, such that the camera's transmitting antenna can be disposed remote from the camera (such as at the front of a trailer when the camera is disposed at the rear of the trailer). The cable and camera and antenna may be temporarily mounted at the trailer, such as via magnetic mounts that magnetically attach the cable and camera and antenna at a metallic trailer. Optionally, the mounts or elements may be adhesively attached to the trailer. Optionally, the mounts or elements may comprise hook and loop type fasteners (e.g., VELCRO® fasteners or the like), with one part adhered to the trailer and another part attached at the camera and cable and antenna, such that the camera and cable and antenna are detachably attached at the trailer via the hook and loop fasteners.

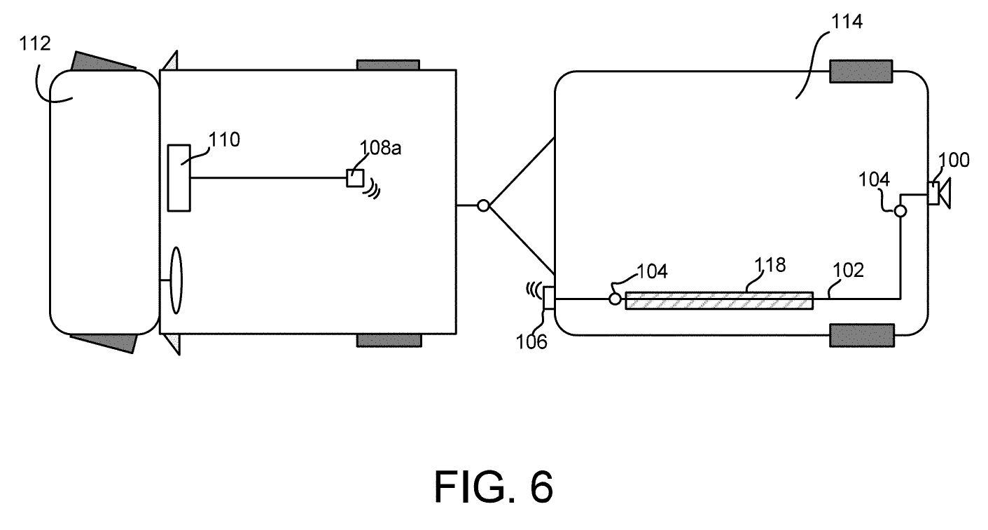

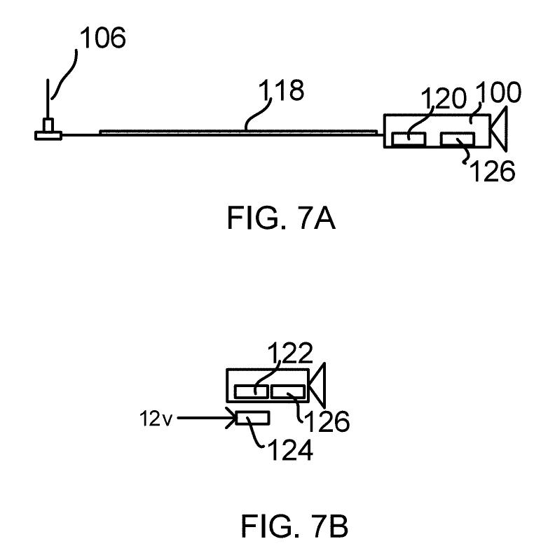

Optionally, and such as shown in FIGS. 6 and 7A, the cable 118 may include a solar panel integrated as part of the antenna cable or attached to and along the antenna cable. The solar panel generates electrical energy, which is communicated to the camera for charging its electrical energy storage module or battery 126. Optionally, the camera may include a vibration energy harvesting module 120, which generates electrical energy responsive to the vibration of the trailer as the vehicle and trailer travel along a road, with the generated electrical energy used for charging its electrical energy storage module or battery 126. Optionally, the system may include a wireless charger module 124 (FIG. 7B) that may be part of the trailer and may be powered via the power source of the vehicle (such as via electrical connection of a wiring harness of the trailer to the vehicle or via a separate 12 volt power source or the like). The wireless charger module 124 charges the camera battery 126 via a wireless charge receive module 122 at the camera.

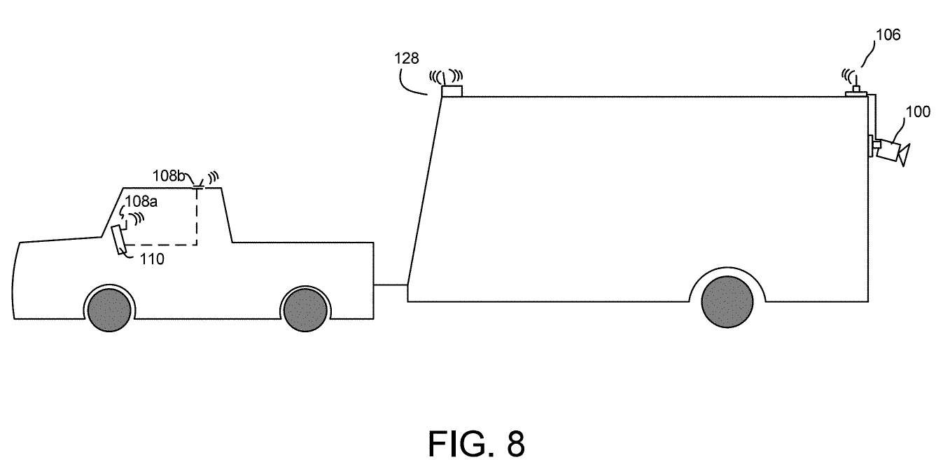

Optionally, and such as shown in FIG. 8, a camera system may have the transmitting antenna 106 disposed at or near the camera 100 (such as via a magnetic mount or the like at the rear of the trailer), and a battery operated wireless repeater 128 disposed at the front of the trailer (such as via a magnetic mount or the like). The repeater 128 repeats the wireless signal generated by the wireless camera 100 and transmitted by the antenna 106, so that the wireless signal is received by the antenna 108a or 108b of the vehicle. Thus, by transmitting the signal or repeating the signal at the front of the trailer, signal strength at the vehicle antenna location will improve.

The vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties.

Optionally, the display for displaying images captured by one or more of the imaging sensors for viewing by the driver of the vehicle while the driver is normally operating the vehicle, may, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, said vehicular vision system comprising:
a camera configured to be disposed at a rear of a trailer so as to have a field of view rearward of the trailer, wherein the camera is operable to capture image data;
a transmitting antenna configured to be disposed at a front of the trailer;
wherein, with the camera and the transmitting antenna disposed at the trailer, the transmitting antenna is electrically connected to the camera via an antenna cable;
wherein, with the camera and the transmitting antenna disposed at the trailer, the transmitting antenna receives, via the antenna cable, image data captured by the camera, and wherein the transmitting antenna wirelessly transmits the received captured image data;
a control disposed at a vehicle towing the trailer, wherein the control comprises a receiving antenna;
a display device comprising a video display screen disposed in the vehicle and viewable by a driver of the vehicle, wherein the control is operable to communicate with the display device;
wherein, with the vehicle towing the trailer, and with the camera and the transmitting antenna disposed at the trailer, captured image data transmitted by the transmitting antenna at the front of the trailer is received at the receiving antenna at the vehicle and is provided to the control; and
wherein the display device, responsive to the control receiving, via the receiving antenna, the transmitted captured image data, displays at the video display screen video images derived from the captured image data received at the receiving antenna and provided to the control.

2. The vehicular vision system of claim 1, wherein the antenna cable is configured to be magnetically attached at the trailer.

3. The vehicular vision system of claim 1, wherein the camera is configured to be magnetically attached at the trailer.

4. The vehicular vision system of claim 1, wherein the transmitting antenna is configured to be magnetically attached at the trailer.

5. The vehicular vision system of claim 1, comprising a charging device for electrically charging a battery of the camera.

6. The vehicular vision system of claim 5, wherein the charging device comprises a solar panel configured to be disposed at the trailer.

7. The vehicular vision system of claim 5, wherein the charging device comprises a vibration energy harvesting module at the camera.

8. The vehicular vision system of claim 5, wherein the charging device comprises a wireless charging module configured to be disposed at the trailer and a wireless charge receive module at the camera, and wherein, with the camera and the wireless charging module disposed at the trailer, the wireless charging module is powered via a power source of the trailer or the vehicle.

9. A vehicular vision system, said vehicular vision system comprising:
a camera configured to be disposed at a rear of a trailer so as to have a field of view rearward of the trailer, wherein the camera is operable to capture image data;
a first transmitting antenna configured to be disposed at the trailer at or near the camera, when the camera is disposed at the rear of the trailer;
wherein, with the camera and the first transmitting antenna disposed at the trailer, the first transmitting antenna receives image data captured by the camera, and wherein the first transmitting antenna wirelessly transmits image data captured by the camera;
a second transmitting antenna configured to be disposed at a front portion of the trailer, wherein, with the camera and the first and second transmitting antennas disposed at the trailer, the second transmitting antenna receives the captured image data transmitted by the first transmitting antenna, and wherein the second transmitting antenna wirelessly transmits the captured image data received from the first transmitting antenna;
a control disposed at a vehicle towing the trailer, wherein the control comprises a receiving antenna;
a display device comprising a video display screen disposed in the vehicle and viewable by a driver of the vehicle;
wherein, with the vehicle towing the trailer, and with the camera and the first and second transmitting antennas disposed at the trailer, captured image data transmitted by the second transmitting antenna at the front of the trailer is received at the receiving antenna at the vehicle and is provided to the control; and
wherein the display device, responsive to the control receiving, via the receiving antenna, displays at the video display screen video images derived from the captured image data received at the receiving antenna and provided to the control.

10. The vehicular vision system of claim 9, wherein the camera is configured to be magnetically attached at the trailer.

11. The vehicular vision system of claim 9, wherein the first and second transmitting antennas are configured to be magnetically attached at the trailer.

12. The vehicular vision system of claim 9, comprising a charging device for electrically charging a battery of the camera.

13. The vehicular vision system of claim 12, wherein the charging device comprises a solar panel configured to be disposed at the trailer.

14. The vehicular vision system of claim 12, wherein the charging device comprises a vibration energy harvesting module at the camera.

15. The vehicular vision system of claim 12, wherein the charging device comprises a wireless charging module configured to be disposed at the trailer and a wireless charge receive module at the camera, and wherein, with the camera and the wireless charging module disposed at the trailer, the wireless charging module is powered via a power source of the trailer or the vehicle.

16. A vehicular vision system, said vehicular vision system comprising:
a camera configured to be disposed at a rear of a trailer so as to have a field of view rearward of the trailer, wherein the camera is operable to capture image data;
wherein the camera is configured to be magnetically attached at the trailer;
a transmitting antenna configured to be disposed at a front of the trailer;
wherein the transmitting antenna is configured to be magnetically attached at the trailer;
wherein, with the camera and the transmitting antenna magnetically attached at the trailer, the transmitting antenna is electrically connected to the camera via an antenna cable;
wherein, with the camera and the transmitting antenna magnetically attached at the trailer, the transmitting antenna receives, via the antenna cable, image data captured by the camera, and wherein the transmitting antenna wirelessly transmits the received captured image data;
a control disposed at a vehicle towing the trailer, wherein the control comprises a receiving antenna;
a display device comprising a video display screen disposed in the vehicle and viewable by a driver of the vehicle, wherein the control is operable to communicate with the display device;
wherein, with the vehicle towing the trailer, and with the camera and the transmitting antenna magnetically attached at the trailer, captured image data transmitted by the transmitting antenna at the front of the trailer is received at the receiving antenna at the vehicle and is provided to the control; and
wherein the display device, responsive to the control receiving, via the receiving antenna, the transmitted captured image data, displays at the video display screen video images derived from the captured image data received at the receiving antenna and provided to the control.

17. The vehicular vision system of claim 16, wherein the antenna cable is configured to be magnetically attached at the trailer.

18. The vehicular vision system of claim 16, comprising a charging device for electrically charging a battery of the camera.

19. The vehicular vision system of claim 18, wherein the charging device comprises a solar panel configured to be disposed at the trailer.

20. The vehicular vision system of claim 18, wherein the charging device comprises a vibration energy harvesting module at the camera.
